(19) United States
(12) Patent Application Publication
(10) Pub. No.: US 2013/0321275 A1
(43) Pub. Date: Dec. 5, 2013

(54) ILLUMINATED KEYBOARD

(71) Applicant: Chin-Wen CHOU, New Taipei City (TW)

(72) Inventor: Chin-Wen CHOU, New Taipei City (TW)

(21) Appl. No.: 13/486,208

(22) Filed: Jun. 1, 2012

(51) Int. Cl. G06F 3/02

(52) U.S. Cl. 345/168

(57) ABSTRACT

An illuminated keyboard includes a keyset portion and at least one light source substrate. The keyset portion includes a plurality of keys and a baseboard to hold the keys and allow the keys to respectively generate a trigger displacement. The keys are arranged in parallel rows to form a plurality of key clusters. The light source substrate is located between any two neighboring key clusters and includes a light transmission channel with an electrode electrically connected to at least one light emitting diode (LED) and is covered by a light transmission element. The LED receives electric power provided by the light source substrate to generate light transmitted via the light transmission channel and projected uniformly to the key clusters via the light transmission element. Hence the illuminated keyboard of the invention can be made thinner and assembled simpler.

### FIELD OF THE INVENTION

The present invention relates to an illuminated keyboard and particularly to an illuminated keyboard with a light source substrate located on a baseboard to provide uniform luminosity and can be made thinner and fabricated in simple process.

### BACKGROUND OF THE INVENTION

Computers are widely used in people's life nowadays. The timing of using the computers also increases significantly. In order to meet these growing requirements computers have evolved from the desktop computers in the past to portable notebook computers or laptop computers, and ultrabooks now that are made in very thin as the main appeal. Whatever the types of the computers, they mostly need a keyboard to enter data or commands. As the situations of using the computer are diversified these days, in a low luminosity or dim environment without sufficient illumination people cannot make accurate keystrokes to output data correctly. In order to enable users to clearly identify legends on the keyboard in the low luminosity or dim environment, many types of illuminated keyboards have been developed, such as U.S. Pat. Nos. 6,284,988, 6,199,996 and 6,179,432. They mostly have a built-in light emission plate to project light outwards to help the users to make accurate keystrokes.

The aforesaid conventional techniques also have keycaps, elastic elements and driven mechanisms that are made of light projecting material. The light emission element is formed in a whole plate as light emission surface to give the entire keyboard uniform backlight. As the illuminated keyboards are mostly used in a low luminosity or dim environment, uniform illumination of the entire keyboard often results in too strong of luminosity to create annoyance to other people in the neighborhood. Moreover, in the low luminosity environment, people's visual sensitivity to objects is lower, light projection of the entire keyboard makes users difficult to identify each keycap. Moreover, light emitted from two neighboring keycaps tends to generate interference and not easy to distinguish. In addition, the aforesaid techniques mostly provide a light guide plate on the baseboard to transmit and project light from light emission elements to the entire keyboard. The light guide plate often is located on the baseboard, on the circuit board, or between the baseboard and the circuit board. The light guide plate is formed at a substantial thickness and makes shrinking the illuminated keyboard difficult. As a result, it is difficult to be adopted on the ultrabooks, and the cost of the illuminated keyboard also is higher.

Furthermore, if positioning a light emission element between any two neighboring keycaps is desired, one set of coupling hole is needed on the baseboard or circuit board of the illuminated keyboard to hold the light emission element. Referring to R.O.C. utility model No. M393732, the position of the coupling hole has to match the overall structure of the illuminated keyboard, such as location of the hole or wiring layout or the like. Such a concern creates a lot of constraints on the design of the illuminated keyboard and also makes assembly of the elements complicated. On the other hand, at present there are many illuminated keyboards with light emission element incorporating with a light guide plate or light guide band to transmit the light generated by the light emission element and project the light to each key unit. The light guide band merely provides light transmission function and could diminish the light, so that the portion close to the light emission element of the light guide band has stronger illumination while that remote from the light emission element has weaker illumination, thus makes uniform light projection impossible.

### SUMMARY OF THE INVENTION

The primary object of the present invention is to solve the problem of the conventional illuminated keyboards that is constrained by the thickness of light guide plate and creates difficulty in miniaturization.

Another object of the invention is to solve the problem of the conventional illuminated keyboards that provides illumination for individual keycaps but cannot generate uniform illumination.

To achieve the foregoing objects, the present invention provides an illuminated keyboard. The illuminated keyboard includes a keyset portion and at least one light source substrate. The keyset portion includes a plurality of keys and a baseboard to hold the keys and allow the keys to respectively generate a trigger displacement. The keys are arranged in parallel rows each forming a key cluster. The light source substrate is located between any two neighboring key clusters and includes a light transmission channel. The light transmission channel has an electrode electrically connected to at least one light emitting diode (LED), and also is covered by a light transmission element so that when the LED receives electric power provided by the light source substrate light is generated and transmitted in the light transmission channel and projected uniformly to the key clusters via the light transmission element.

In one embodiment the light transmission element is made of light conductive resin filling the light transmission channel or a light guide plate covering the upper opening of the light transmission channel. The light guide plate has a light emission trough to hold the LED.

In another embodiment the light source substrate is covered by a light shielding sheet which includes a transparent zone and an opaque zone. The transparent zone corresponds to each key.

In yet another embodiment the light transmission channel is formed at a cross section which can be polygonal, semicircular or irregular.

In yet another embodiment each key includes a keycap, a driven mechanism located between the keycap and baseboard and an elastic element located in the driven mechanism. The elastic element provides a return force to the keycap to allow the key to move in the trigger displacement against the baseboard. The baseboard has at least one holding portion to hold the driven mechanism. The keyset portion includes a circuit board located between the baseboard and keycap to generate an output command during the trigger displacement of the keycap. The circuit board is located above the baseboard, and the light source substrate is located above the circuit board.

In yet another embodiment the light transmission channel further includes a plurality of light projecting portions respectively corresponding to one key and communicating with the light transmission channel.

By means of the structure set forth above, compared with the conventional techniques, the illuminated keyboard of the invention provides features as follows:

1. The keyboard can be made thinner. By positioning the light source substrate between any two key clusters, the light guide plate covering the entire illuminated keyboard in the conventional techniques can be omitted. The illuminated keyboard thus formed is not constrained by the thickness of the light guide plate and can be formed thinner.

2. Save production cost. With the light source substrate located between any two key clusters, the light guide plate covering the entire illuminated keyboard occurred to the conventional techniques can be dispensed with, thus the cost of the light guide plate also can be saved.

3. Simpler assembly. As the light source substrate is directly located above the keyset, there is no need to fabricate other openings, and also no need to redo wiring layout.

4. Enhanced light projection uniformity. The invention has the light transmission channel in the light source substrate that contains at least one LED. Light can be transmitted through the light transmission element. Compared with the conventional techniques with the LEDs located only at two sides of the light guide band, the invention is not constrained by the light guide band and can generate more uniform light projection effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the illuminated keyboard of the invention.

FIG. 2 is a fragmentary top view of an embodiment of the invention.

FIG. 3A is a cross section of an embodiment of the invention.

FIG. 3B is a fragmentary cross section of the invention with an enlarged light source substrate.

FIG. 4 is a cross section of a first embodiment of the light source substrate of the invention.

FIG. 5 is a cross section of a second embodiment of the light source substrate of the invention.

FIG. 6 is a cross section of a third embodiment of the light source substrate of the invention.

FIG. 7 is a cross section of a fourth embodiment of the light source substrate of the invention.

FIG. 8 is a cross section of a fifth embodiment of the light source substrate of the invention.

FIG. 9 is a cross section of a sixth embodiment of the light source substrate of the invention.

### DETAILED DESCRIPTION OF THE PREFERRED EMBODIMENTS

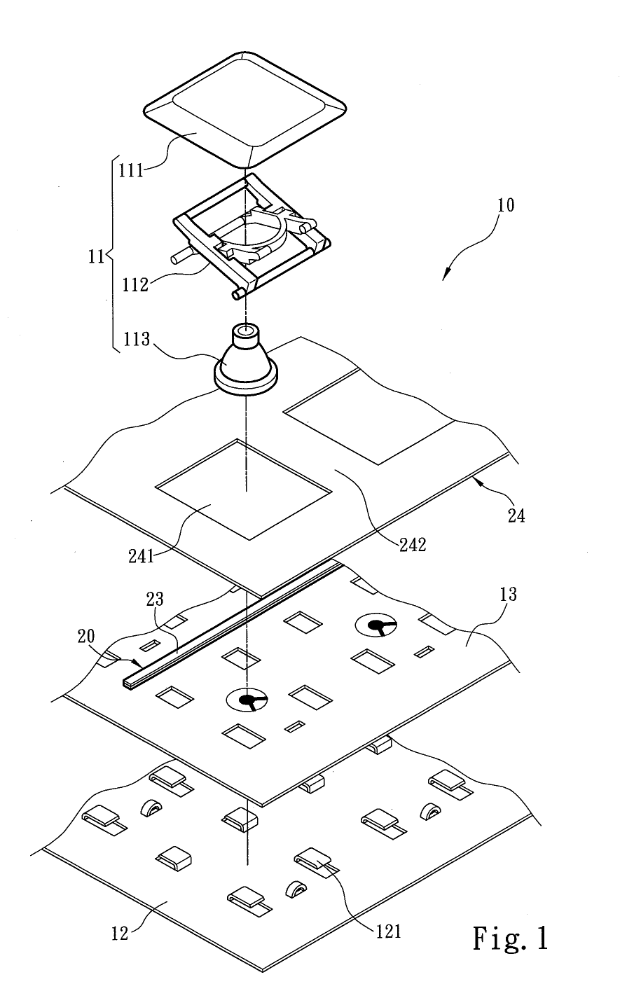

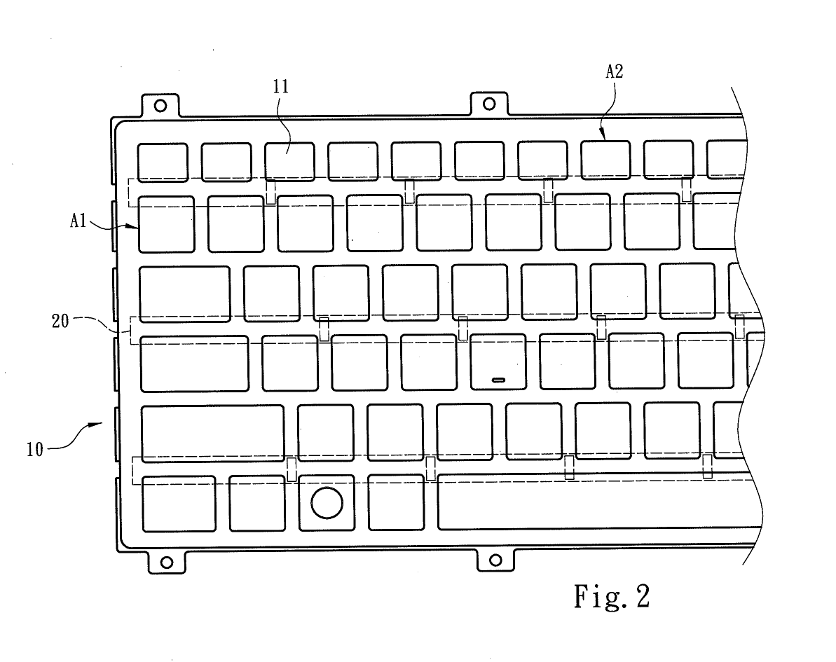

Please refer to FIGS. 1 and 2 for an embodiment of the illuminated keyboard of the invention. The illuminated keyboard includes a keyset portion 10 and at least one light source substrate 20. The keyset portion 10 includes a plurality of keys 11 and a baseboard 12 to hold the keys 11 and allow the keys 11 to respectively generate a trigger displacement. The keys 11 are arranged in parallel rows each forming a key cluster A1. Each key 11 includes a keycap 111, a driven mechanism 112 located between the keycap 111 and baseboard 12 and an elastic element 113 located in the driven mechanism 112. The elastic element 113 provides a return force to the keycap 111 to allow the key 11 to move in the trigger displacement against the baseboard 12. The baseboard 12 has at least one holding portion 121 to hold the driven mechanism 112. The keyset portion 10 includes a circuit board 13 located between the baseboard 12 and keycap 111 to generate an output command during the trigger displacement of the keycap 111. The circuit board 13 can be located above the baseboard 12, and the light source substrate 20 can be coupled on the upper side of the circuit board 13. The structure shown in the drawings merely serves as an example and is not the limitation of the invention.

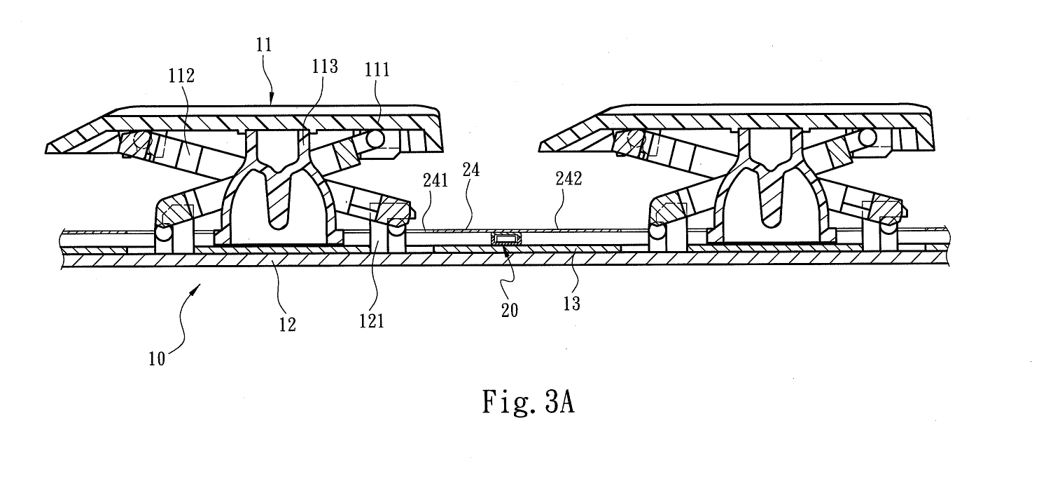

Also refer to FIGS. 3A and 3B for an embodiment of the illuminated keyboard and light source substrate. The light source substrate 20 is located on the baseboard 20 between any two neighboring key clusters A1 and A2, and has a light transmission channel 21 which can be made by an etching process during fabrication of the light source substrate 20. The light transmission channel 21 includes an electrode 211 electrically connected to at least one LED 22. The electrode 211 is located in the light transmission channel 21 and spaced from each other at a desired distance. The light transmission channel 21 further is covered by a light transmission element 23 on an upper side thereof so that when the LED 22 receives electric power provided by the light source substrate 20 light is generated and transmitted in the light transmission channel 21 and projected uniformly to the key cluster A1 or A2. In one embodiment the electrode 211 is formed at two sides of the light source substrate 20, and the light transmission channel 21 is formed between the electrodes 211.

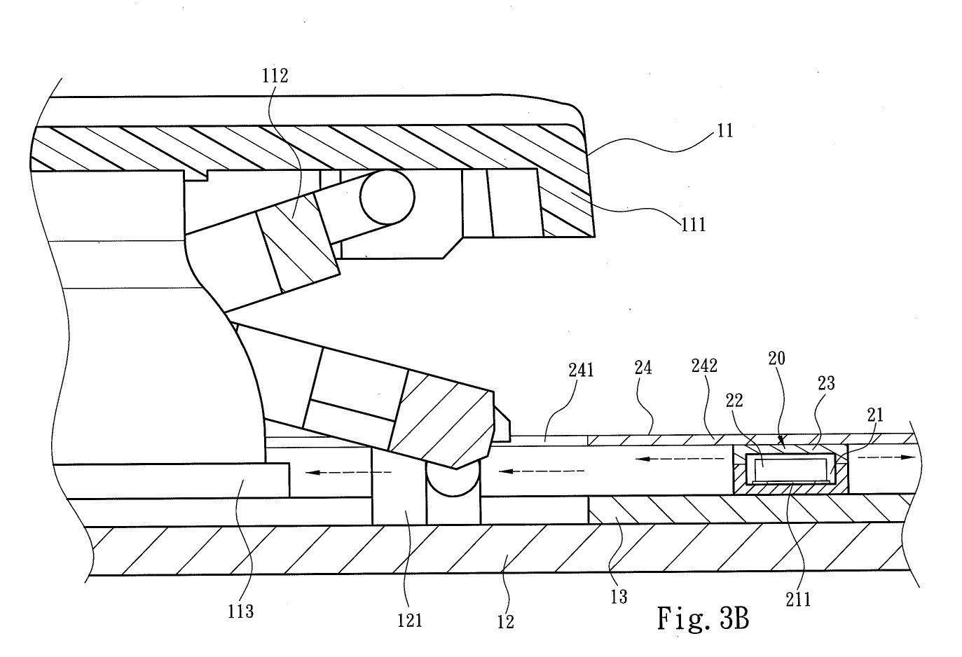

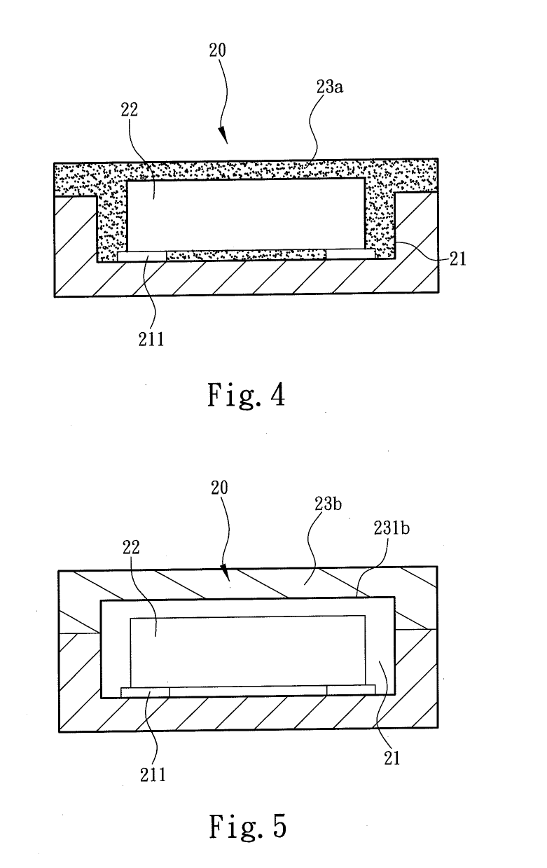

In the invention the light source substrate 20 is located between any two neighboring key clusters A1 and A2 of the keyset 10 and generates light projecting to the key clusters A1 or A2. In this embodiment, the light transmission element 23a can be made of light conductive resin filling the light transmission channel 21 as shown in FIG. 4, or a light guide plate 23b covering the light transmission channel 21 as shown in FIG. 5. The light guide plate 23b includes a light emission trough 231b to hold the LED 22. Also referring to FIG. 3B, the light source substrate 20 further is covered by a light shielding sheet 24. The light shielding sheet 24 includes a transparent zone 241 and an opaque zone 242. The transparent zone 241 corresponds to each key 11 so that the light generated by the light source substrate 20 is transmitted in the opaque zone 242 and projects through the transparent zone 241 to the corresponding key 11. The light shielding sheet 24 can locally cover the light source substrate 20 or fully cover the circuit board 13. This embodiment takes the fully cover as an example, but this is not the limitation of the invention. The light shielding sheet 24 further can be opaque and made of a hard material or flexible material.

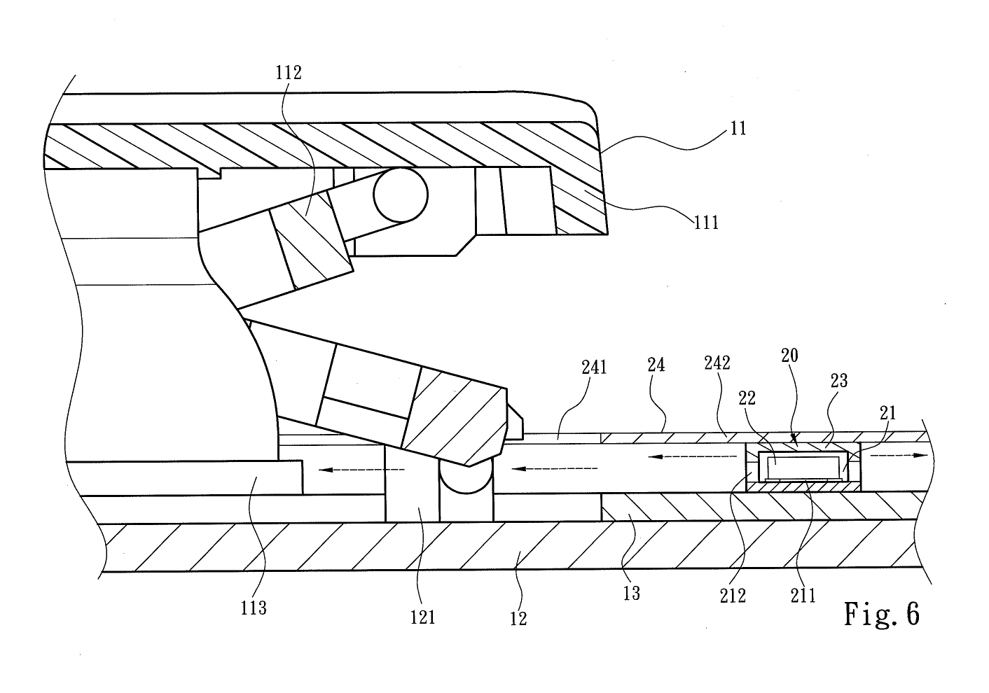

Please refer to FIG. 6 for a third embodiment of the illuminated keyboard in which the light transmission channel 21 further includes a plurality of light projecting portions 212 respectively corresponding to the key 11. The light projecting portions 212 are formed by running through the light source substrate 20 via the light transmission channel 21. Hence when the light source substrate 20 is located between any two neighboring key clusters, the light projecting portions 212 on the light transmission channel 21 respectively correspond to the key 11. When the light transmits in the light transmission channel 21, it can directly project to the keys 11 to provide illumination.

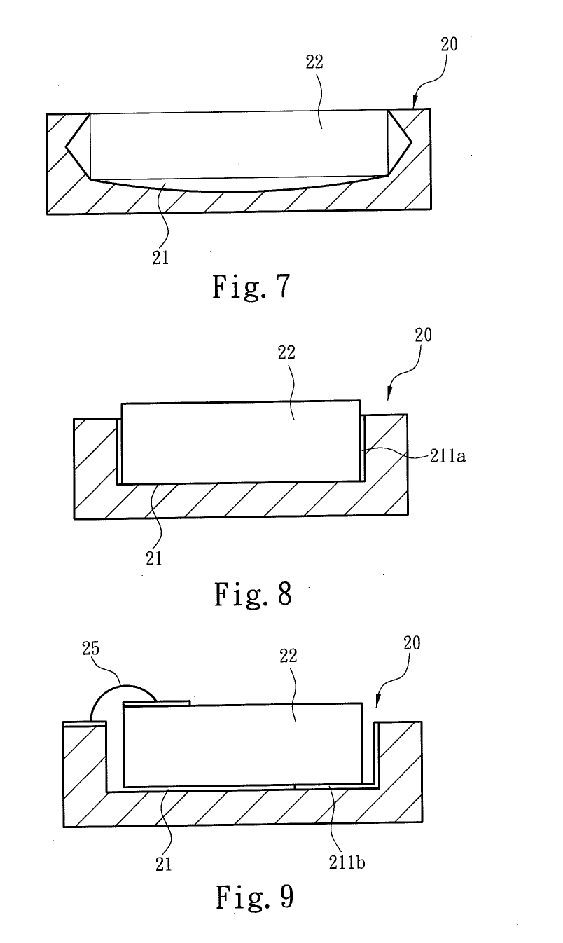

Please refer to FIG. 7 for the light source substrate of a fourth embodiment of the invention. The cross section of the light transmission channel 21 can be polygonal, semicircular or irregular. The varying shapes of cross section of the light transmission channel 21 also affect light projection angles or scattering of the light source substrate 20. Also refer to FIGS. 8 and 9 for fifth and sixth embodiments of the light source substrates of the invention. Aside from FIG. 3B, the electrode 211a also can be located at two sides of the light transmission channel 21 as shown in FIG. 8 with the width of the light transmission channel 21 same as the LED 22 so that when the LED 22 is held in the light transmission channel 21 it can be connected to the electrode 211a at two sides of the light transmission channel 21; or the electrode 211b can be located on the edge of the light transmission channel 21 or on the light source substrate 20 as shown in FIG. 9 to form electric connection with the LED 22 via an electric connection line 25. All the embodiments previously discussed merely serve for illustrative purpose and are not the limitations of the invention.

As a conclusion, the illuminated keyboard of the invention has at least one light source substrate located between any two neighboring key clusters of the keyset portion. The light source substrate includes a light transmission channel containing at least one LED and is covered by a light transmission element on the upper side. Light generated by the LED can provide uniform luminosity for the key clusters through the light transmission element. Through the aforesaid structure the illuminated keyboard does not need a light guide plate of a greater size so that the keyboard can be made thinner. Moreover, there is also no need to form openings on the baseboard or change wiring of the circuit board, therefore design and assembly of the illuminated keyboard is much simpler, and total cost is lower. It provides significant improvements over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illuminated keyboard, comprising:
a keyset portion including a plurality of keys and a baseboard to hold the plurality of keys and allow the plurality of keys to respectively generate a trigger displacement, the plurality of keys being arranged in parallel rows to form a plurality of key clusters; and
at least one light source substrate which is located on the baseboard between any two neighboring keys clusters and includes a light transmission channel which includes an electrode electrically connected to at least one light emitting diode and is covered by a light transmission element on an upper side thereof, the at least one light emitting diode receiving electric power provided by the at least one light source substrate to generate light transmitted via the light transmission channel and projected uniformly to the plurality of key clusters via the light transmission element.

2. The illuminated keyboard of claim 1, wherein the light source substrate is covered by a light shielding sheet which includes a transparent zone and an opaque zone.

3. The illuminated keyboard of claim 2, wherein the transparent zone corresponds to each of the plurality of keys.

4. The illuminated keyboard of claim 1, wherein the light transmission element is made of light conductive resin filling the light transmission channel.

5. The illuminated keyboard of claim 4, wherein the light source substrate is covered by a light shielding sheet which includes a transparent zone and an opaque zone.

6. The illuminated keyboard of claim 5, wherein the transparent zone corresponds to each of the plurality of keys.

7. The illuminated keyboard of claim 1, wherein the light transmission element is a light guide plate to cover an upper opening of the light transmission channel.

8. The illuminated keyboard of claim 7, wherein the light source substrate is covered by a light shielding sheet which includes a transparent zone and an opaque zone.

9. The illuminated keyboard of claim 8, wherein the transparent zone corresponds to each of the plurality of keys.

10. The illuminated keyboard of claim 7, wherein the light guide plate includes a light emission trough to hold the light emitting diode.

11. The illuminated keyboard of claim 1, wherein the electrode is located at two sides of the light source substrate to form the light transmission channel between them.

12. The illuminated keyboard of claim 11, wherein the light source substrate is covered by a light shielding sheet which includes a transparent zone and an opaque zone.

13. The illuminated keyboard of claim 12, wherein the transparent zone corresponds to each of the plurality of keys.

14. The illuminated keyboard of claim 1, wherein the light transmission channel further includes a plurality of light projecting portions respectively corresponding to each of the plurality of keys and communicating with the light transmission channel.

15. The illuminated keyboard of claim 14, wherein the light source substrate is covered by a light shielding sheet which includes a transparent zone and an opaque zone.

16. The illuminated keyboard of claim 15, wherein the transparent zone corresponds to each of the plurality of keys.

17. The illuminated keyboard of claim 1, wherein the light transmission channel is formed in a polygonal or semicircular cross section.

18. The illuminated keyboard of claim 1, wherein the light transmission channel is formed in an irregular cross section.

19. The illuminated keyboard of claim 1, wherein each of the plurality of keys includes a keycap, a driven mechanism located between the keycap and the baseboard and an elastic element located in the driven mechanism, the elastic element providing a return force to the keycap to allow the key to move in the trigger displacement relative to the baseboard.

20. The illuminated keyboard of claim 19, wherein the baseboard includes at least one holding portion to hold the driven mechanism.

21. The illuminated keyboard of claim 19, wherein the keyset portion includes a circuit board located between the baseboard and the keycap to generate an output command during the trigger displacement of the keycap.

22. The illuminated keyboard of claim 21, wherein the circuit board is located above the baseboard.

23. The illuminated keyboard of claim 21, wherein the light source substrate is coupled on an .upper side of the circuit board.
